(19) United States
(12) Patent Application Publication
(10) Pub. No.: US 2024/0223606 A1
(43) Pub. Date: Jul. 4, 2024

(54) NETWORK BASED SCAM RESPONSE

(71) Applicant: T-MOBILE INNOVATIONS LLC, Overland Park, KS (US)

(72) Inventors: Derrick Lynn IVES, North Bend, WA (US); Melodie Magdalene SOBRENILLA, Sumner, WA (US)

(21) Appl. No.: 18/147,317

(22) Filed: Dec. 28, 2022

(51) Int. Cl. H04L 9/40; H04L 41/16

(52) U.S. Cl. CPC H04L 63/1483; H04L 41/16

(57) ABSTRACT

According to aspects herein, methods and systems for management of a scam likely communication and a networks response therein. A network may identify that an incoming communication is likely to be a scam and send that communication to a scam response component rather than the intended user device. The scam response component may then initiate a scam response BOT to respond and initiate interactions with the scam likely sender. The scam response BOT is designed to maximize the time spent on the communication by the scam likely sender.

### BACKGROUND

In the network environment, people receive many scam related communications that take up valuable time and network resources. The economics of scam calls relies on the scammer being able to call many people to find the few who fall for their tactics. If the scammers were tied up with calls, those economics fall apart.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

Thus far, artificial intelligence and BOTs (aka robots) have not been successful in accomplishing the goal of breaking scammer economics. If BOTs were implemented at the network level, scammers would be tied up on calls that would lead nowhere. In the present disclosure, scam calls are intercepted by the network and given to a network level BOT. The BOT initiates a conversation with the scam caller in an attempt to tie the scammer up for the longest possible amount of time. The BOT may use artificial intelligence and machine learning to identify what responses it can use to manipulate the scammer into staying on the call the longest. By doing this, the network level BOT creates a time wasting activity, tying up the scammer's available resources in conversations that will not lead to receipt of money, and prevents them from being able to communicate with potential scam targets.

### BRIEF DESCRIPTION OF THE SEVERAL VIEWS OF THE DRAWINGS

Implementations of the present disclosure are described in detail below with reference to the attached drawing figures, wherein:

FIG. 1 depicts a computing environment suitable for use in implementations of the present disclosure, in accordance with aspects herein;

FIG. 2 depicts a diagram of an exemplary network environment in which implementations of the present disclosure may be employed, in accordance with aspects herein;

FIG. 3 depicts a diagram of an exemplary network environment in which implementations of the present disclosure may be employed, in accordance with aspects herein; and

FIG. 4 is a flowchart of a method in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. Various technical terms are used throughout this description. An illustrative resource that fleshes out various aspects of these terms can be found in Newton's Telecom Dictionary, 32nd Edition (2022).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

In the current telecommunications environment, scam calls are tagged and sent to the end user. The end user has the opportunity to answer or not, even though the call is tagged as a scam-likely call. Current network environments do not prevent scam calls from reaching the end user but merely indicate that they are likely to be scams. Additionally, scam networks prey on the vulnerable and use mass calling to reach their targets. As such, if a network were able to intercept scam calls and prevent scammers from continuing to call innocent victims, those scam networks may be disrupted.

The current disclosure described herein provides a mechanism for disrupting scam networks and provides a means for wasting scammer's time. Inbound calls are initially tagged by the network as scams based on the call's origin and other call related information. The network may then intercept the call and prevents it from reaching the final destination of the end user. By intercepting the call, the network at least prevents its users from being subjected to the scam calls.

Once the network has intercepted the scam call, a scam response artificial intelligence agent, or scam response agent, is able to answer the call as would a targeted user. For example, the scam response agent is able to answer “hello, this is Andrew” and wait for the scammer to respond. The scammer then may respond with a scam introduction and request such as “your car's extended warranty is about to expire, would you like to extend it?” The scam response agent is able to determine, based on the scam introduction, what type of scam it is and how best to respond. The best responses by the scam response agent will be ones that keep the conversation going as long as possible. Ideally, the scam response agent will provide responses to the scammer that will cause the scammer to continue the conversation thinking it has found an ideal target. Since the scam response agent is merely operating on a network server, there is no time limit and many scammers may be tied up simultaneously. Thus, if implemented network wide, the scammer's economics will be broken.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, 6G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB). In this regard, typically only one active uplink connection can occur per frequency. The base station may include one or more sectors served by individual transmitting/receiving components associated with the base station (e.g., antenna arrays controlled by an EnodeB). These transmitting/receiving components together form a multi-sector broadcast arc for communication with mobile handsets linked to the base station.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point.

In accordance with a first aspect of the present disclosure, a method for managing a scam likely call and response. The method begins with receiving from a first user device, by a network, a first scam likely communication request. Subsequently, the method provides for communicating to the first user device, by the network, a first response. An initial communication is received from the first user device and based on that initial communication a first scam communication type is determined. The second response is then communicated to the first user device.

A second aspect of the present disclosure is directed to one or more non-transitory computer-readable media having computer-executable instructions embodied thereon that, when executed, perform a method. The method begins with receiving from a first user device, by a network, a first scam likely communication request. Subsequently, the method provides for communicating to the first user device, by the network, a first response. An initial communication is received from the first user device and based on that initial communication a first scam communication type is determined. The second response is then communicated to the first user device.

Another aspect of the present disclosure is directed to a non-transitory computer storage media storing computer-usable instructions that, that when used by the processor, cause the processor to perform the following operations: receive from a first user device, by a network, a first scam likely communication request. Subsequently, the instructions provide for communicating to the first user device, by the network, a first response. An initial communication is received from the first user device and based on that initial communication a first scam communication type is determined. The second response is then communicated to the first user device.

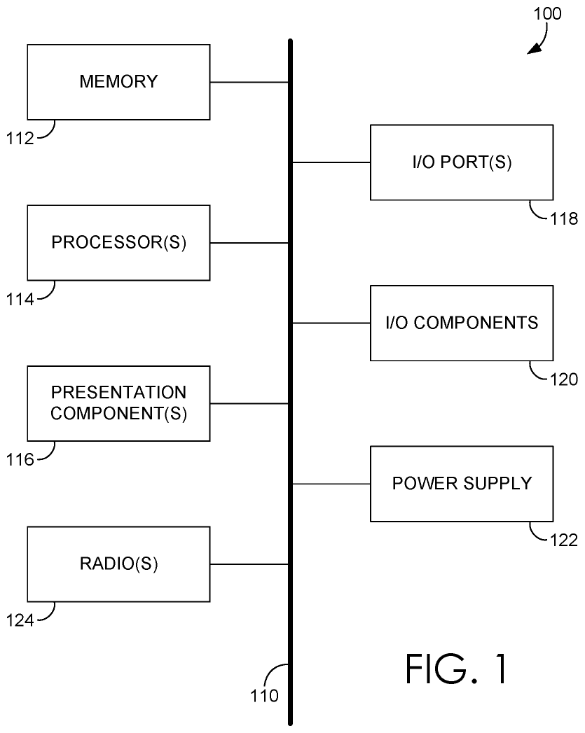

FIG. 1 depicts a computing environment suitable for use in implementations of the present disclosure. In particular, the exemplary computer environment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 may be a UE, or other user device, capable of two-way wireless communications with an access point. Some non-limiting examples of the computing device 100 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 112, I/O components 110, radio 116, transmitter 118, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 110. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes BOTh volatile and nonvolatile media, removable and non-removable media. By way of example, and not limitation, computer-readable media may comprise computer storage media and communication media. Computer storage media includes BOTh volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, non-removable, or a combination thereof. Exemplary memory includes solid-state memory, hard drives, optical-disc drives, etc. Computing device 100 includes one or more processors 106 that read data from various entities such as bus 102, memory 104 or I/O components 110. One or more presentation components 108 present data indications to a person or other device. Exemplary one or more presentation components 108 include a display device, speaker, printing component, vibrating component, etc. I/O ports 112 allow computing device 100 to be logically coupled to other devices including I/O components 110, some of which may be built into computing device 100. Illustrative I/O components 110 include a microphone, joystick, game pad, satellite dish, scanner, printer, wireless device, etc.

The radio 116 represents one or more radios that facilitate communication with a wireless telecommunications network. While a single radio 116 is shown in FIG. 1, it is contemplated that there may be more than one radio 116 coupled to the bus 102. In aspects, the radio 116 utilizes a transmitter 118 to communicate with the wireless telecommunications network. It is expressly conceived that a computing device with more than one radio 116 could facilitate communication with the wireless telecommunications network via both the transmitter 118 and an additional transmitters (e.g. a second transmitter). Illustrative wireless telecommunications technologies include CDMA, GPRS, TDMA, GSM, and the like. The radio 116 may additionally or alternatively facilitate other types of wireless communications including Wi-Fi, WiMAX, LTE, 3G, 4G, LTE, 5G, NR, VOLTE, or other VoIP communications. As can be appreciated, in various embodiments, radio 116 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

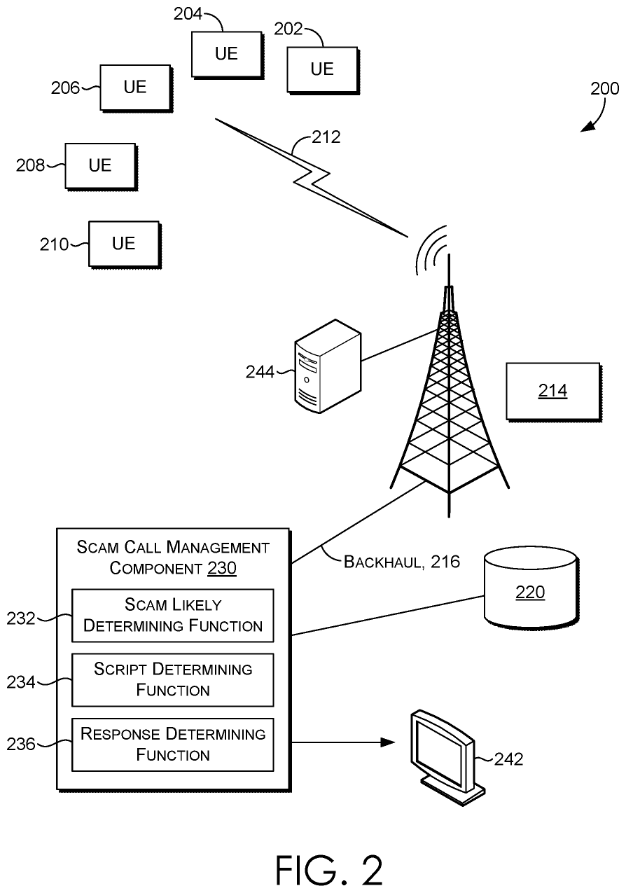

FIG. 2 depicts a diagram of an exemplary network environment in which implementations of the present disclosure may be employed. Such a network environment is illustrated and designated generally as network environment 200. Network environment 200 is not to be interpreted as having any dependency or requirement relating to any one or combination of components illustrated.

Network environment 200 includes user devices (UE) 202, 204, 206, 208, and 210, access point 214 (which may be a cell site, base station, or the like), and one or more communication channels 212. In network environment 200, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 100) that communicates via wireless communications with the access point 214 in order to interact with a public or private network.

In some aspects, each of the UEs 202, 204, 206, 208, and 210 may correspond to computing device 100 in FIG. 1. Thus, a UE can include, for example, a display(s), a power source(s) (e.g., a battery), a data store(s), a speaker(s), memory, a buffer(s), a radio(s) and the like. In some implementations, for example, a UEs 202, 204, 206, 208, and 210 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, 6G, or any other type of network. Each of the UEs 202, 204, 206, 208, and 210 may receive incoming communications and/or send communications through the access point 214.

In some cases, UEs 202, 204, 206, 208, and 210 in network environment 200 can optionally utilize one or more communication channels 212 to communicate with other computing devices (e.g., a mobile device(s), a server(s), a personal computer(s), etc.) through access point 214. The network environment 200 may be comprised of a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) can provide connectivity in various implementations. Network environment 200 can include multiple networks, as well as being a network of networks, but is shown in more simple form so as to not obscure other aspects of the present disclosure.

The one or more communication channels 212 can be part of a telecommunication network that connects subscribers to their immediate telecommunications service provider (i.e., home network carrier). In some instances, the one or more communication channels 212 can be associated with a telecommunications provider that provides services (e.g., 3G network, 4G network, LTE network, 5G network, and the like) to user devices, such as UEs 202, 204, 206, 208, and 210. For example, the one or more communication channels may provide voice, SMS, and/or data services to UEs 202, 204, 206, 208, and 210, or corresponding users that are registered or subscribed to utilize the services provided by the telecommunications service provider. The one or more communication channels 212 can comprise, for example, a 1x circuit voice, a 3G network (e.g., CDMA, CDMA2000, WCDMA, GSM, UMTS), a 4G network (WiMAX, LTE, HSDPA), or a 5G network.

In some implementations, access point 214 is configured to communicate with a UE, such as UEs 202, 204, 206, 208, and 210, that are located within the geographic area, or cell, covered by radio antennas of access point 214. Access point 214 may include one or more base stations, base transmitter stations, radios, antennas, antenna arrays, power amplifiers, transmitters/receivers, digital signal processors, control electronics, GPS equipment, and the like. In particular, access point 214 may selectively communicate with the user devices using dynamic beamforming.

As shown, access point 214 is in communication with a scam call management component 230 and at least a network database 220 via a backhaul channel 216. The access point may also host a server 244 that stores applications and metaverse content that are frequently requested by users in the vicinity of access point 214. As the UEs 202, 204, 206, 208, and 210 collect individual preference data, the preference data can be automatically communicated by each of the UEs 202, 204, 206, 208, and 210 to the access point 214. Access point 214 may store the data communicated by the UEs 202, 204, 206, 208, and 210 at a network database 220. Alternatively, the access point 214 may automatically retrieve the personal or user data from the UEs 202, 204, 206, 208, and 210, and similarly store the data in the network database 220.

As described above, the preference data collected by the UEs 202, 204, 206, 208, and 210 can include, for example, scam call preference information, historical scam settings, historical scam interactions, scam response scripts, and the like. In one embodiment, the historical information includes prior interactions the user has had with likely scam calls or any other interactions that may be stored within the database. Historical scam information and historical scam interactions may be stored therein. The network database 220 may be user specific and store information related to the user of each UE 202-210. Each user may have a separate account and profile stored with the network database 220. The profile will have information and preferences related to the scam call management component 230. The network database 220 will also contain machine learning algorithms and historical training data related to the scam likely determining function 232 within the scam call management function 230. The database will also contain machine learning algorithms and historical training data related to the response determining function 236 within the scam call management function 230.

The scam call management component 230 comprises various engines including a scam likely determining function 232, a script determining function 234, and a response determining function 236, where the scam call management component 230 may be stored at the network database 220. Although the scam call management component 230 is shown as a single component comprising the scam likely determining function 232, the script determining function 234, and the response determining function 236, it is also contemplated that each of the scam likely determining function 232, the script determining function 234, and the response determining function 236 may reside at different locations, be its own separate entity, and the like, within the home network carrier system.

The scam call management component 230 allows a mobile network to host an application server, such as server 244 in the mobile operator's location. This brings the server 244 closer to the UEs, such as UEs 202, 204, 206, 208, and 210, reducing latency for the UEs. The server 244 may operate using the scam call management component 230 an application which manages incoming calls which are likely to be scam calls. The Scam call management component 230 operates the application within the network fielding incoming calls and managing the calls and incoming communications which are determined to be likely scam communications. The incoming communications may be an incoming call, video call, SMS text message, call within a metaverse, or any other communication. The scam call management component 230 may also operate the application on various networks simultaneously. The user may be able to access the scam call management component 230 and provide personalized scam call or communication settings to the application. For example, the user may input that they do not wish to receive any scam likely communications and for the scam call management component 230 to manage all scam likely calls without notifying the user. Additionally, the user may desire to be notified of a scam likely call and decide if the scam call management component 230 manages the communication or if the user wishes to respond. The user may select additional options such as how a scam response BOT will respond. The options for the scam response may be, but is not limited to, gender of the BOT, age of the BOT, accent of the BOT, or any other personalized information the user wishes for the BOT to have. In one embodiment, the BOT is an agent, which is able to communicate by way of autonomous speech. The scam call management component 230 directs the BOT is what to say and how to say it. The BOT is designed as an autonomous program and can interact with systems and users.

In one embodiment, the scam call management component 230 receives an incoming call or communication wishing to communicate with one or more of the UEs 202-210. The incoming communication in one example is tagged as scam likely. This may be accomplished from an external network or some other portion of the network environment 200 not described herein. For example, if a UE from an external network is trying to communicate with UE 202 and the external network establishes that the communication is likely to be a scam, the external network may indicate to the network environment 200 that the communication is likely to be a scam. Thus the communication will be sent to the scam call management component 230.

In another embodiment, the request to communicate with one or more UEs 202-210 is initially screened by the scam call management component 230. The scam likely determining function 232 within the scam call management component 230 operates to determine if an incoming communication is likely to be a scam. This is done using machine learning algorithms trained to detect scam calls. The machine learning algorithms are trained using historical incoming calls. Additionally, the scam likely determining function 232 identifies scam likely communications using historical call data stored within network database 220. The scam likely determining function 232 may determine that an incoming communication is above a threshold likelihood of being a scam and will thus tag or identify the communication as a scam. The scam likely determining function 232 will then send the communication to the script determining function 234 within the scam call management component 230.

The script determining function 234 is provided for determining the type of scam or script the incoming communication is. For example, many incoming scam calls follow a particular pattern of inquiries. From these inquiries, the script determining function 234 is able to identify which line of questioning the scam communication will use. There are a finite number of types of scam communications and the script determining function 234 is able to match the initial line of questions from the scam communicator to a known script. The script determining function 234 in one embodiment uses a comparison of the initial questions from the scam communicator to a known list of scam scripts to determine which script is being used. In an additional embodiment, the script determining function 234 uses machine learning to determine the likely script the scam communicator will use. Additionally, the script determining function 234 may modify the script determination after a few questions and answer series. For example, the initial question from the scam communicator may indicate that the communication is a first type of scam but after two more questions from the scam communicator, the script determining function 234 may change the script assignment to a second scam type.

In one embodiment, the script determining function 234 determines the type of scam communication prior to the initial response by the scam response BOT. The script determining function 234 is able to use the origin and other information about the communication to identify the type of script the scam communication will likely follow. Information gathered prior to the initial response may be historical information about the origin of the communication, IP address information, frequency information, and other pertinent information about the communication.

The script determining function 234 works in conjunction with the response determining function 236. The script determining function 234 initially will cause the scam call management component 230 to activate a scam response BOT to answer the scam likely communication. The script determining function 234 will indicate to the response determining function if an initial script has been identified prior to the initial response. As such, the initial answer will be determined by the response determining function 236. The initial response from the scam response BOT will be determined by the response determining function 236 based on an initial script identification or a generic initial response. For example, if no script has been identified, the response determining function 236 cause the scam response BOT to answer the scam likely communication with a generic answer or greeting such as “hello”. The response determining function 236 uses machine learning to actively learn which responses or answers will cause the scam communicator to continue and not end the communication. For example, if an initial greeting is more likely to cause the communication to continue, the response determining function 236 will cause the scam response BOT the use that initial greeting.

Once the initial greeting has been communicated by the scam response BOT, the script determining function 234 will assess the scam communicator's response. The script determining function 234 will then, based on the scam communicator's response, assign the scam communication a script. The script assignment is communicated to the response determining function 236. The response determining function 236 will then determine a next response by the scam response BOT. For example, the scam communicator may indicate that a social security number has been compromised. In response, the script determining function will identify that the script to be used is the social security fraud script. Additionally, the response determining function 236 will then determining the best way to respond such as to cause the scam communicator to continue the communication.

The script determining function 234 and the response determining function 236 will then continue so long as the scam communication is active. In one embodiment, the script determining function will not change the initial script determination. In an additional embodiment, the script determining function will change the script dynamically as the communication progresses. Additionally, the response determining function 236 will respond to each communication from the scam communicator with a response tailored to the communication. The response determining function 236 will use machine learning and set scripts to determine which response is most likely to keep the communication going.

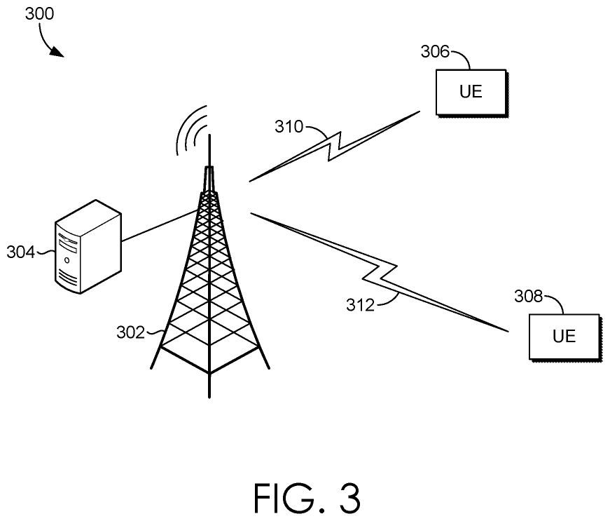

FIG. 3 depicts a diagram of an exemplary network environment in which implementations of the present disclosure may be employed. Such a network environment is illustrated and designated generally as network environment 300. Network environment 300 is not to be interpreted as having any dependency or requirement relating to any one or combination of components illustrated.

Network environment 300 comprises a network access point 302, a server 304, a scam UE 306, a network UE, a scam communication channel 310, and a BOT communication channel 312. In one embodiment the scam UE may be a cell phone, a landline, a handheld device, a computer, a scam BOT, a laptop, or any other user device. The scam UE 306 may send an initial communication by way of the scam communication channel 310. The initial communication is intended for the network UE 308 which may be any UE served by network environment 300. The scam communication channel 310 may be a wired or wireless communication channel. The initial communication is intercepted by the network access point 302 and determine, by the server 304, to be a scam likely communication. Once the communication is determined to be a scam likely, the server then indicates that the communication is not to be sent to the network UE 308 and is to be managed by the server 304.

The server can then determine an initial response by a scam response avatar or BOT. The server 304 then continues to initiate communications with the scam UE 306. Such communications are described above in more detail. For example, the server 304 determines that a first response will continues to the communication. If the scam likely communication is determined to not be a scam after an initial response, the server 304 will then cause the communication to be forwarded by the network access point 302 to the network UE 308.

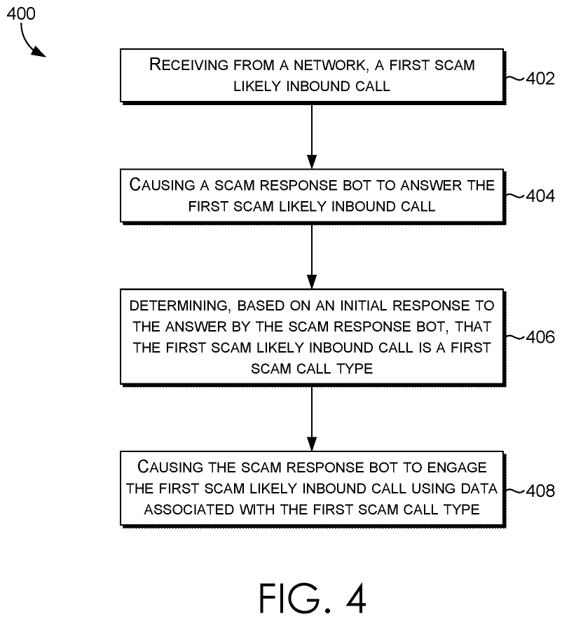

FIG. 4 is a flowchart of a method for managing a scam response agent. The method 400 begins in step 402 with receiving from a network, a first scam likely inbound call. The inbound or request to communicate is received at a network access point. The communication that is likely to be a scam is identified by the network as a scam likely communication. Once the communication is determined to be a scam likely call or communication, the communication held from being delivered or communicated from the access point to the end user device. The server associated with the network for the end user device, in one embodiment, uses machine learning to determine if an incoming call is a scam likely call or not. If the call is determined to be not scam likely, the call proceeds as normal to the end user device or terminating device.

At step 404, the server causes a scam response BOT or agent to answer the first scam likely inbound call. In aspects herein BOT and agent may be used synonymously. The scam response BOT answers the scam likely inbound call with a generic answer that will most likely lead to the communication proceeding between the scam likely call UE and the scam response BOT. The BOT may be personalized such that it looks a particular way and sounds a particular way with particular clothing, hair, looks, gender, speech patterns, language, overall looks, demeanor, and many other particular portions of the BOT. By personalizing the BOT, the likelihood of continuing the conversation with a scam agent is increased. For example, if the BOT were to act and sound like an elderly woman, the scam agent may be more likely to maintain conversation with the BOT. The initial response by the BOT may be tailored to the origin of the call or a determination that the call is likely to be a particular type of scam.

Now looking at step 406, the server determines, based on an initial response to the answer by the scam response BOT, that the first scam likely inbound call is a first scam call type. Once the BOT answers the call, the scam agent will respond with an initial response. The server may then determine that the pattern of the scam agent's initial response indicates that the scam likely call is a first scam type from a set of types of scams. For example, if the scam agent were to responds by indicating that your student loan may be forgiven, the system may determine that the scam is likely to follow a particular pattern. The pattern is determined based on historical interactions and machine learning algorithms as described herein

At step 408, the system causes the scam response BOT to engage the first scam likely inbound call using data associated with the first scam call type. The system uses pattern recognition, machine learning, or any other algorithm to determine the first scam call type. The first scam type provides an indication of how the scam response BOT should respond. The system will determine, based on the initial scam response and the scam type, how to respond such that the communication will continue for the longest time possible. For example, if the scam is a car warranty scam and the initial scam response was to see if the user would like to learn more. In this scenario, the system may use machine learning to determine that a particular response will elicit a positive response from the scam agent. The system will analyze a number of possible scenarios and determine which response to cause to the BOT to engage the scam agent with. Further, the scam agent will responds to the engagement and the system will repeat and determine a best response for the next interaction by the scam response BOT. The process will continue as long as the scam agent actively responds to the scam response BOT's interactions.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. A method for managing a network based scam response comprising:
at a scam response agent in a network, intercepting a scam communication request intended for a user device;
in response to the scam communication request, communicating to a scam device, by the network, a first response;
receiving a scam communication from the scam device;
determining a scam type based on the scam communication;
based on the scam type and the scam communication, determining a second response; and
communicating the second response to the scam device.

2. The method of claim 1, wherein the scam communication request is associated with a known scamming entity.

3. The method of claim 1, further comprising:
receiving a request to communicate with the user device;
determining that the request to communicate with the user device is the scam communication request.

4. The method of claim 3, wherein the determining that the request to communicate with the user device is the scam communication request is done using machine learning.

5. The method of claim 1, wherein the scam communication request is intercepted prior to the scam communication request being communicated to the user device.

6. The method of claim 1, wherein the first response is a generic phone call answer.

7. The method of claim 1, wherein the scam type is determined using pattern recognition.

8. The method of claim 1, wherein the scam type is determined using machine learning.

9. The method of claim 1, wherein the scam type is determined using pattern recognition and machine learning.

10. The method of claim 1, wherein the second response is determined based on a probability that the scam device will respond to the second response.

11. One or more non-transitory computer-readable media having computer-executable instructions embodied thereon that, when executed, perform a method for managing a network based scam response comprising:
at a scam response agent in a network, intercepting a scam communication request intended for a user device;
in response to the scam communication request, communicating to a scam device, by the network, a first response;
receiving a scam communication from the scam device;
determining a scam type based on the scam communication;
based on the scam type and the scam communication, determining a second response; and
communicating the second response to the scam device.

12. The method of claim 11, further comprising determining that a request to communicate is the scam communication request.

13. The method of claim 11, wherein the scam communication request is intercepted prior to the scam communication request being communicated to the user device.

14. The method of claim 11, wherein the first response is a generic phone call answer.

15. The method of claim 11, wherein the scam type is determined using pattern recognition.

16. The method of claim 11, wherein the scam type is determined using pattern recognition and machine learning.

17. A system for using a mobile drone delivery device, the system comprising:
one or more processors; and
one or more computer storage hardware devices storing computer-usable instructions that, when used by the one or more processors, cause the one or more processors to:
at a scam response agent in a network, intercept a scam communication request intended for a user device;
in response to the scam communication request, communicate to a scam device, by the network, a first response;
receive a scam communication from the scam device;
determine a scam type based on the scam communication;
based on the scam type and the scam communication, determine a second response; and
communicate the second response to the scam device.

17. The method of claim 16, further comprising determining that a request to communicate is the scam communication request.

18. The method of claim 16, wherein the scam communication request is intercepted prior to the scam communication request being communicated to the user device.

19. The method of claim 16, wherein the scam type is determined using a pattern recognition algorithm and a machine learning algorithm.
